(19) United States
(12) Patent Application Publication
(10) Pub. No.: US 2022/0119143 A1
(43) Pub. Date: Apr. 21, 2022

(54) CONVEYOR AND MEDICINE INSPECTION SUPPORT SYSTEM

(71) Applicant: FUJIFILM Toyama Chemical Co., Ltd., Tokyo (JP)

(72) Inventors: Hirokazu OKUTSU, Minamiashigara-shi (JP); Tomohisa YOSHIDA, Tokyo (JP)

(73) Assignee: FUJIFILM Toyama Chemical Co., Ltd., Tokyo (JP)

(21) Appl. No.: 17/567,427

(22) Filed: Jan. 3, 2022

Related U.S. Application Data
(63) Continuation of application No. PCT/JP2020/033045, filed on Sep. 1, 2020.

(30) Foreign Application Priority Data
Sep. 10, 2019 (JP) 2019-164628

(51) Int. Cl. B65B 43/12; B65B 43/26

(52) U.S. Cl. CPC B65B 43/123; B65B 43/267

(57) ABSTRACT

A conveyor capable of detecting a cut line of portion packaging bags, and a medicine inspection support system are provided. The conveyor conveys the portion packaging bags to an inspecting machine, the portion packaging bags being divided one by one with use of a heat seal portion and perforations by a portion packaging machine and being continuously discharged in a longitudinal posture from the portion packaging machine. The conveyor includes a posture changing device configured to change the longitudinal posture of the portion packaging bags to a lateral posture; and a detector configured to detect a cut line of the portion packaging bags.

### CROSS-REFERENCE TO RELATED APPLICATIONS

The present application is a Continuation of PCT International Application No. PCT/JP2020/033045 filed on Sep. 1, 2020 claiming priority under 35 U.S.C § 119(a) to Japanese Patent Application No. 2019-164628 filed on Sep. 10, 2019. Each of the above applications is hereby expressly incorporated by reference, in its entirety, into the present application.

### BACKGROUND OF THE INVENTION

### 1. Field of the Invention

The present invention relates to a conveyor and a medicine inspection support system.

### 2. Description of the Related Art

In recent years, hospitals and pharmacies have introduced a portion packaging machine and an inspecting machine. The portion packaging machine automates a dispensing and packaging work for packing medicine into portion packaging bags based on prescription data. The inspecting machine automates an inspection work for inspecting whether medicine is packed in portion packaging bags in accordance with the prescription data. Various conveyors have also been proposed to feed portion-packaged portion packaging bags discharged from the portion packaging machine to the inspecting machine.

In the portion packaging machine, portion packaging bags are conveyed in a longitudinal posture, while in the inspecting machine, the portion packaging bags are conveyed in a lateral posture. Conveyors in Japanese Patent Application Laid-Open No. 2002-019712 and Japanese Patent No. 6388049 include a posture changing mechanism that changes the posture of the portion packaging bags from the longitudinal posture to the lateral posture.

### SUMMARY OF THE INVENTION

Incidentally, portion packaging bags have perforations formed by a portion packaging machine to separate the portion packaging bags from each other. Therefore, when the posture of the portion packaging bags is changed in the conveyor, unintended force may be added to the portion packaging bags, resulting in a cut line generated on the portion packaging bags along the perforations.

When the portion packaging bags in the state of having the cut line pass through the conveyor and the inspecting machine, the portion packaging bags may be clogged in a conveyance path, which may put the conveyor and the inspecting machine in a state of not operating normally.

The present invention has been made in view of such circumstances, and an object of the present invention is to provide a conveyor capable of detecting a cut line of portion packaging bags and a medicine inspection support system.

A conveyor of a first aspect conveys portion packaging bags to an inspecting machine, the portion packaging bags being divided one by one with use of a heat seal portion and perforations by a portion packaging machine and being continuously discharged in a longitudinal posture from the portion packaging machine. The conveyor includes a posture changing device configured to change the longitudinal posture of the portion packaging bags to a lateral posture; and a detector configured to detect a cut line of the portion packaging bags. According to the first aspect, it is possible to detect the cut line in each of the portion packaging bags.

In the conveyor of a second aspect, the detector is arranged on an upstream side of the posture changing device. According to the second aspect, the detector is provided on the upstream side of the posture changing device where a cut line tends to be generated on the portion packaging bags.

In the conveyor of a third aspect, the detector includes a photosensor having a light-emitting element and a light-receiving element arranged so as to face each other with a distance, and an actuator configured to determine one state out of an optical path blocking state and an optical path opening state of the photosensor in response to contact with the portion packaging bag.

In the conveyor of a fourth aspect, the actuator determines optical path opening of the photosensor in response to contact with the portion packaging bag.

According to the third and fourth aspects, the actuator determines one of the optical path blocking state and the optical path opening state of the photosensor, which can provide more reliable detection of the cut line.

In the conveyor of a fifth aspect, the posture changing device is a first roller arranged in a direction perpendicular to a conveying direction of the portion packaging bags and in a horizontal direction. According to the fifth aspect, it is possible to easily change the posture of the portion packaging bags.

The conveyor of a sixth aspect includes a second roller configured to press the portion packaging bags together with the first roller, the second roller being arranged so as to face the first roller. According to the sixth aspect, it is possible to suppress generation of wrinkles or the like in the portion packaging bags.

In the conveyor of a seventh aspect, the posture changing device is a guide. According to the seventh aspect, it is possible to easily change the posture of the portion packaging bags.

The conveyor of an eighth aspect includes a third roller configured to guide the portion packaging bags that have passed the posture changing device in a vertically upward direction and a horizontal direction. According to the eighth aspect, the portion packaging bags can be guided to a position of an introduction port of the inspecting machine.

A medicine inspection support system according to a ninth aspect includes: a portion packaging machine configured to portion-package medicine based on prescription data, and continuously discharge portion packaging bags in a longitudinal posture, the portion packaging bags being divided one by one with use of a heat seal portion and perforations; the conveyor configured to convey the portion packaging bags discharged from the portion packaging machine; and an inspecting machine configured to receive the portion packaging bags continuously fed from the conveyor, and inspects the medicine portion-packaged into the portion packaging bags based on the prescription data. According to the ninth aspect, it is possible to detect the cut line in each of the portion packaging bags.

The medicine inspection support system according to a tenth aspect includes a controller configured to control the portion packaging machine, the conveyor, and the inspecting machine. The controller stops operation of the medicine inspection support system and/or issues an alarm in accordance with a result of the detector of the conveyor. According to the tenth aspect, it becomes possible to promptly cope with the generation of a cut line in each of the portion packaging bags.

According to the present invention, it is possible to detect a cut line in the portion packaging bags.

### BRIEF DESCRIPTION OF THE DRAWINGS

FIG. 1 is a schematic diagram showing the configuration of a medicine inspection support system according to an embodiment.

FIG. 2 is a block diagram showing the configuration of the medicine inspection support system.

FIG. 3 is an enlarged view of a packaging mechanism included in a portion packaging machine.

FIG. 4 is an enlarged view of the portion packaging machine and the conveyor in the state where no cut line is generated on portion packaging bags.

FIG. 5 is a partially perspective view of the portion packaging machine and the conveyor in the state where no cut line is generated on the portion packaging bags.

FIG. 6 is a partially enlarged view of the portion packaging machine and the conveyor in the state where a cut line is generated on the portion packaging bags.

FIG. 7 is a partially perspective view of the portion packaging machine and the conveyor in the state where a cut line is generated on the portion packaging bags.

FIG. 8 is a table showing outlined operation of the detector.

### DESCRIPTION OF THE PREFERRED EMBODIMENTS

Hereinafter, a preferred embodiment of the present invention is described based on the accompanying drawings. The present invention is described with the preferred embodiment described below. Changes are possible by a number of methods without departing from the scope of the present invention, and embodiments other than the embodiment to be described below are also usable. Therefore, all the changes within the scope of the present invention are embraced in the claims.

Here, components designated by similar reference numerals correspond to similar elements having similar functions. Moreover in the description, numerical ranges expressed by “A to B” include an upper limit numeral and a lower limit numeral expressed by “A to B”.

Medicine dispensing works performed in hospitals, pharmacies, and so on, are roughly include a prescription data input work, a picking work, an automated dispensing and packaging work, a dispensing inspection work, and a medicine administration guidance and prescription work. In the medicine administration guidance and prescription work, a pharmacist provides medicine administration guidance and prescribes portion-packaged medicine to a patient after the dispensing inspection.

In the prescription data input work, the pharmacist inputs prescription data written on a prescription into a receipt computer (not shown). Examples of the prescription data may include name and age of a patient, a medicine type or a medicine name, a medicine quantity, medicine usage, or a medicine dosage. In the specification, the term of the medicine type is synonymous with medicine class or medicine category.

The pharmacist then operates the receipt computer to print the prescription data from a printer connected to the receipt computer.

In the picking work, based on the prescription data on a print output from the printer, the pharmacist picks up medicines corresponding to the prescription data from pharmacy shelves. Examples of medicines may include tablet and capsule medicines. Here, in the picking work, an automated picking apparatus that automatically picks up medicines based on the prescription data that is input into the receipt computer may be used, for example.

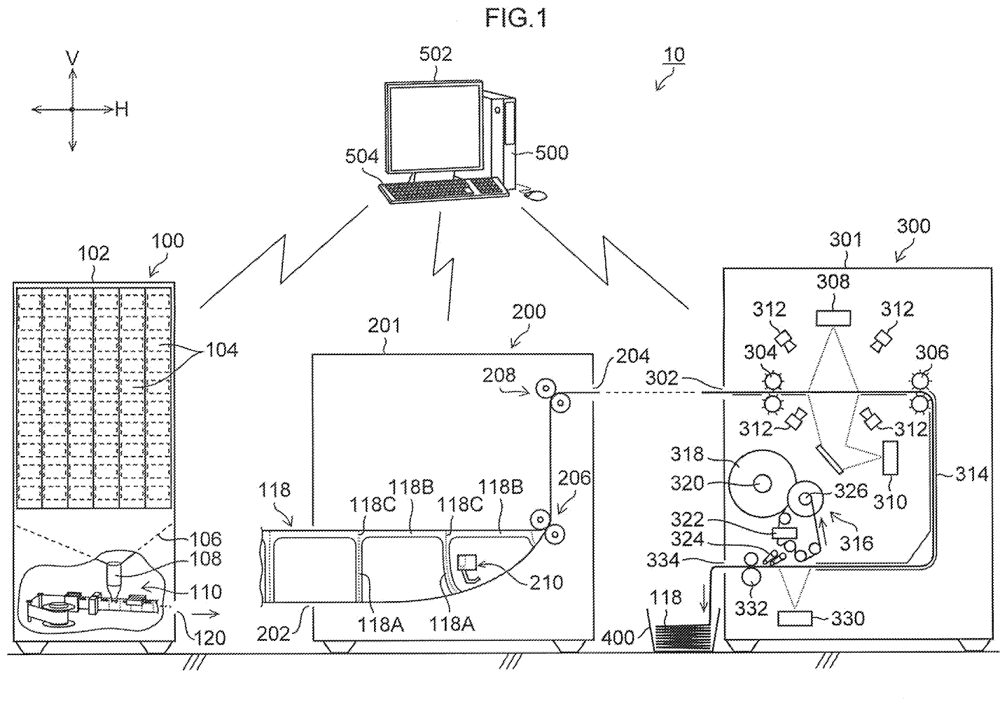

FIG. 1 is a schematic configuration diagram showing a medicine inspection support system. As shown in FIG. 1, a medicine inspection support system 10 includes a portion packaging machine 100, a conveyor 200, an inspecting machine 300, and a controller 500 that controls the portion packaging machine 100, the conveyor 200 and the inspecting machine 300.

In the specification, “upper” and “lower” indicating directions refer to “upper” and “lower” directions for the case where the medicine inspection support system is installed under normal usage. As for “longitudinal” and “lateral”, a vertical (V) direction refers to “longitudinal”, and vertical includes approximately vertical. For example, when the vertical direction is 0°, a range of ±20° is included. A horizontal (H) direction refers to “lateral”, and horizontal includes approximately horizontal. For example, when the horizontal direction is 0°, a range of ±20° is included. As for “longitudinal posture” and “lateral posture”, the terms “longitudinal” and “lateral” are determined based on a short (or width) direction of continuous portion packaging bags. As for “upstream” and “downstream”, a conveying direction side relating to the portion packaging paper or the conveying direction of the portion packaging bags with respect to a certain reference refers to “downstream”, and the opposite side of the conveying direction refers to “upstream”.

<Controller>

Examples of the controller 500 may include a personal computer. The controller 500 receives prescription data that is input online from the receipt computer. For example, the controller 500 includes a display part 502 constituted of a display device, and an operating part 504 constituted of a keyboard.

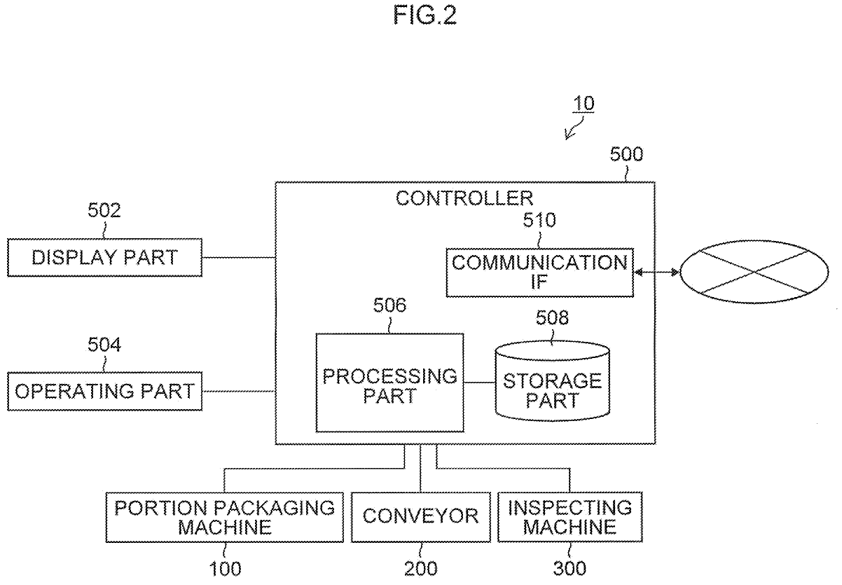

FIG. 2 is a block diagram showing the configuration of the medicine inspection support system 10. As shown in FIG. 2, the controller 500 is electrically connected to the portion packaging machine 100, the conveyor 200, the inspecting machine 300, the display part 502, and the operating part 504. The controller 500 includes a processing part 506 that performs various control, a storage part 508 that stores various data, and a communication interface 510 that performs data communication with external networks. The controller 500 is connected to the receipt computer via the communication interface 510.

<Portion Packaging Machine>

As shown in FIG. 1, the portion packaging machine 100 has a casing 102. The portion packaging machine 100 includes a plurality of feeders 104 for storing a plurality of medicines. The plurality of feeders 104 is arranged longitudinally and laterally. The plurality of feeders 104 may include the plurality of feeders 104 arranged on the rear side as viewed from the front side. The feeders 104 can drop down the stored medicines one at a time.

Based on the prescription data, the controller 500 can select a required feeder 104 and drop the stored medicines down from the feeder 104. The medicine of one dose is dropped down. The feeders 104 can each be constituted of a cassette for housing medicine and a chute that guides the medicine down from the cassette.

The portion packaging machine 100 includes a hopper 106 below the feeders 104. The hopper 106 is a cylindrical member with a wide opening on the upper side and a narrow opening on the lower side, the narrow opening being narrower than the wide opening. The hopper 106 collects medicines dropped from the upper feeders 104 and gathers the medicines to one spot on the lower side. Under the hopper 106, an input pipe 108 is provided.

The portion packaging machine 100 includes a packaging mechanism 110 below the input pipe 108. The tablets collected with the hopper 106 are guided to the packaging mechanism 110 through the input pipe 108. The input pipe 108 is a cylindrical member extending in a vertical direction. The input pipe 108 may be circular or elliptical in cross section. The input pipe 108 may also be in a cylindrical or pyramid shape. The input pipe 108 may be in any shape as long as the input pipe 108 can guide the tablets to the packaging mechanism 110.

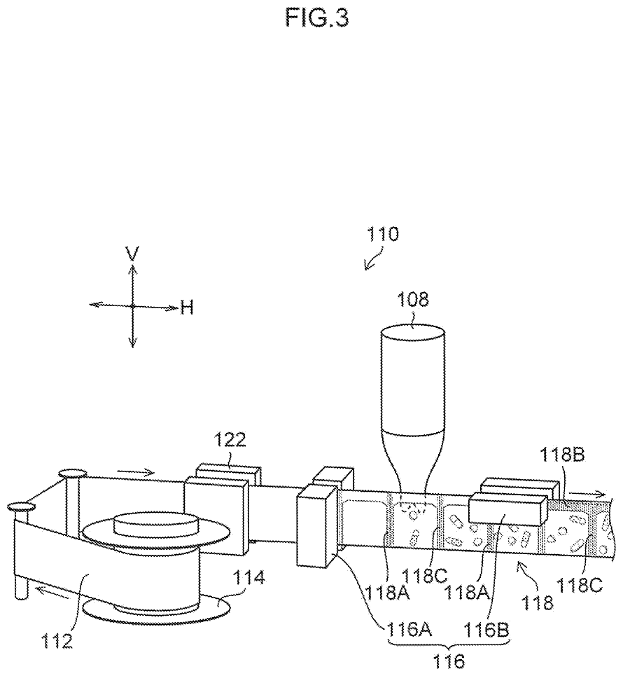

As shown in FIG. 3, the packaging mechanism 110 includes a supply mechanism 114 to feed the portion packaging paper 112, and a heat seal mechanism 116 to heat-fuse the portion packaging paper 112. The portion packaging paper 112 is made of a heat-fusible material. The portion packaging paper 112 is made of a long-length sheet folded in two in a short direction and rolled in the folded state.

The heat seal mechanism 116, for example, has a longitudinal heat head 116A arranged longitudinally and a lateral heat head 116B arranged laterally. The heat seal mechanism 116 can form longitudinal seal portions 118A and lateral seal portions 118B on the portion packaging paper 112 to be conveyed.

The supply mechanism 114, for example, is constituted of a shaft that holds the rolled portion packaging paper 112 and a drive motor that rotates the shaft or the like. The controller 500 can rotationally drive the drive motor intermittently or continuously.

The portion packaging paper 112 is conveyed in a longitudinal posture with a double-folded portion being positioned on the lower side. For example, the longitudinal heat head 116A of the heat seal mechanism 116 forms the longitudinal seal portions 118A on the portion packaging paper 112. The longitudinal heat head 116A of the heat seal mechanism 116 is equipped with a perforation forming device (not shown). The perforation forming device, for example, includes a plurality of blades or the like that can penetrate the portion packaging paper 112. When the longitudinal heat head 116A heat-fuses the portion packaging paper 112 from both sides, the perforation forming device forms perforations 118C on the longitudinal seal portions 118A. The portion packaging paper 112 is put in a half-closed state.

Then, the half-closed portion packaging paper 112 passes through the input pipe 108. Medicine of one dose is supplied from the input pipe 108 to the half-closed portion packaging paper 112. Then, the lateral heat head 116B of the heat seal mechanism 116 forms the lateral seal portions 118B.

The portion packaging paper 112 is formed into portion packaging bags 118 which are separated from each other through the heat seal portions (the longitudinal seal portions 118A and the lateral seal portions 118B) and the perforations 118C.

The portion packaging machine 100 discharges continuous portion packaging bags 118 in a longitudinal posture from a discharge port 120. The short direction of the continuous portion packaging bags 118 is along the longitudinal direction.

Note that the continuous portion packaging bags 118 are separated into individual portion packaging bags 118 by separating the continuous portion packaging bags 118 along the perforations 118C.

The packaging mechanism 110 may include a printhead 122. The printhead 122 carries out printing in areas of the portion packaging paper 112 which serves as the portion packaging bags after passing through the heat seal mechanism 116. Information to be printed includes, for example, a patient name, a medicine name, and its usage.

<Inspecting Machine>

The inspecting machine 300 has a casing 301. The casing 301 includes an introduction port 302 that receives the continuous portion packaging bags 118, and a discharge port 334 that discharges the continuous portion packaging bags 118. The inspecting machine 300 includes a pair of first conveying rollers 304 on an upstream side and a pair of second conveying rollers 306 on a downstream side. The first conveying rollers 304 and the second conveying rollers 306 hold the continuous portion packaging bags 118 from the upper and lower directions and the lateral seal portions 118B. Holding the lateral seal portions 118B makes it possible to avoid the medicine being trapped and damaged by the first conveying rollers 304 and the second conveying rollers 306.

In a conveying path between the first conveying rollers 304 and the second conveying rollers 306, an imaging area is provided. In the imaging area, a first camera 308 is arranged above the conveying path, and a second camera 310 is arranged below the conveying path. The first camera 308 and the second camera 310 are digital cameras, for example.

A plurality of light sources 312 is arranged above and below the conveying path. Above the conveying path, four light sources 312 are arranged at equal intervals on the same circumference around an imaging optical axis of the first camera 308. Similarly, below the conveying path, four light sources 312 are arranged at equal intervals on the same circumference around an imaging optical axis of the second camera 310.

The imaging area of the conveying path is made of a transparent member. The first camera 308 and the second camera 310 image the medicines contained in the portion packaging bags 118 to be conveyed, from the upper and lower directions. In the imaging area, the portion packaging bags 118 are subjected to posture change from the longitudinal posture at the time of being discharged from the portion packaging machine 100 to the lateral posture by the conveyor 200 described later. The portion packaging bag 118 is put in a horizontal state. A surface enclosed by the longitudinal seal portion 118A, the lateral seal portion 118B, and the double-fold portion of the portion packaging bags 118 are put in the horizontal state.

It is preferable to provide a spreading mechanism (not shown) in the imaging area. The spreading mechanism eliminates overlap of medicines in each of the portion packaging bags 118. By operating the spreading mechanism, the first camera 308 and the second camera 310 can accurately image the medicines in each of the portion packaging bags 118.

A guide 314 is arranged downstream of the imaging area. The guide 314 guides the portion packaging bags 118 to the lower conveying path.

The inspecting machine 300 includes a label printer mechanism 316. A third camera 330 is arranged at a position facing the label printer mechanism 316 across the conveying path. The third camera 330 images the perforations 118C formed in the longitudinal seal portion 118A of the portion packaging bag 118 to detect the position of the perforations 118C. The position of label application is adjusted based on the detected position of the perforations 118C.

The label printer mechanism 316 includes a supply mechanism 320 that feeds a backing paper 318 with labels, a label printer 322, a label release mechanism 324, and a winding mechanism 326 that winds the backing paper. The supply mechanism 320, for example, is constituted of a shaft that holds the rolled backing paper 318 with labels and a drive motor that rotates the shaft or the like. The label printer 322, for example, is constituted of a thermal head printer. The winding mechanism 326 is constituted of a shaft that winds the backing paper 318 without labels, and a drive motor that rotates the shaft or the like. By folding the backing paper 318 with labels, the tip of the printed label tip is released from the backing paper. By passing the released printed labels through a pair of belt conveying mechanisms, the printed labels are conveyed toward the portion packaging bags 118. The printed labels are attached to the portion packaging bags 118.

It is possible to use both or one of the printhead 122 of the packaging mechanism 110 and the label printer mechanism 316 of the inspecting machine 300.

Downstream of the label printer mechanism 316, a pair of third conveying rollers 332 is arranged. The third conveying rollers 332 discharge the continuous portion packaging bags 118 with labels from a discharge port 334. The portion packaging bags 118 discharged from the discharge port 334 are housed in a housing box 400. Although the housing box 400 is shown in the embodiment, a winding device may be arranged instead of the housing box 400. The winding device is constituted of a winding shaft, and a drive motor that drives the winding shaft or the like.

<Conveyor>

As shown in FIG. 1, the conveyor 200 has a casing 201. The casing 201 includes an introduction port 202 that receives the continuous portion packaging bags 118, and a discharge port 204 that discharges the continuous portion packaging bags 118. The conveyor 200 includes a pair of roller parts 206 and a pair of roller parts 208 along the upstream side to the downstream side. In the embodiment, a detector 210 is arranged on the upstream side of the pair of roller parts 206 to detect a cut line of the portion packaging bags 118. As long as the detector 210 is installed in the conveyor 200, the arrangement position thereof is not particularly restricted. Here, for easy understanding, the conveyor 200 is enlarged and displayed.

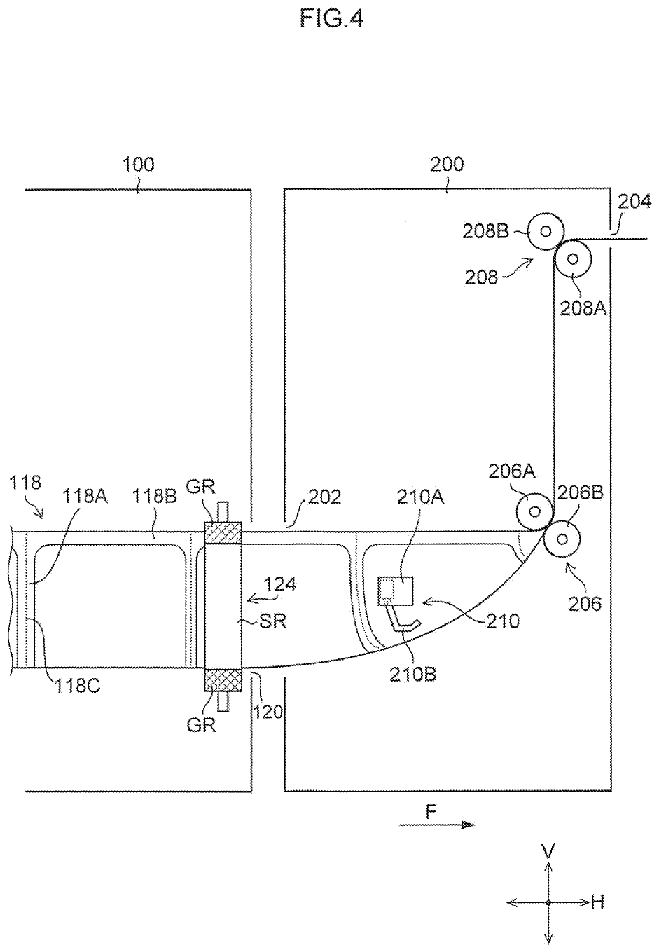

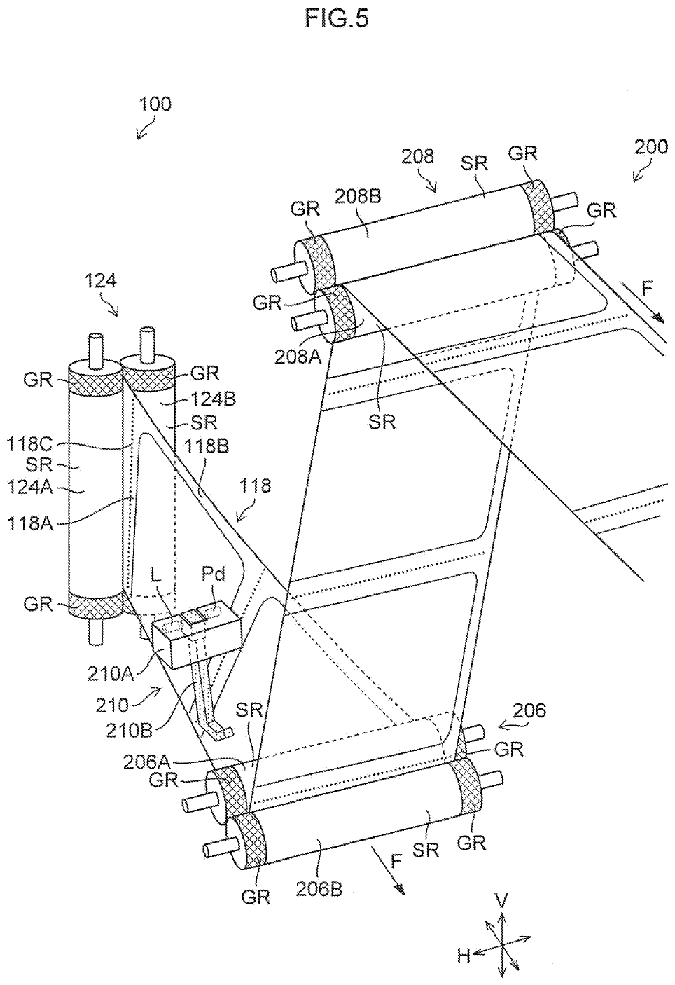

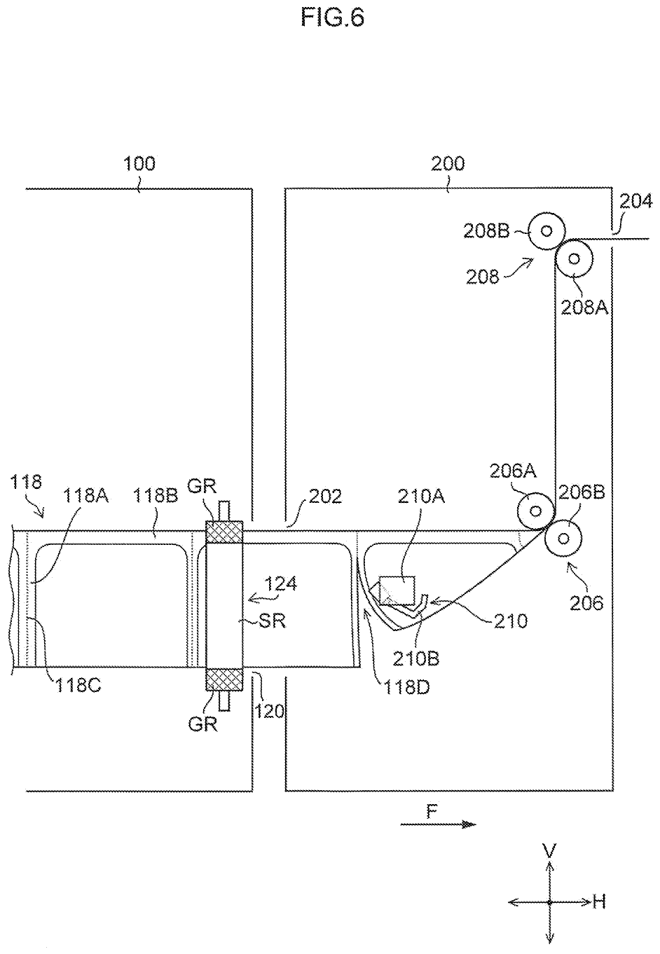

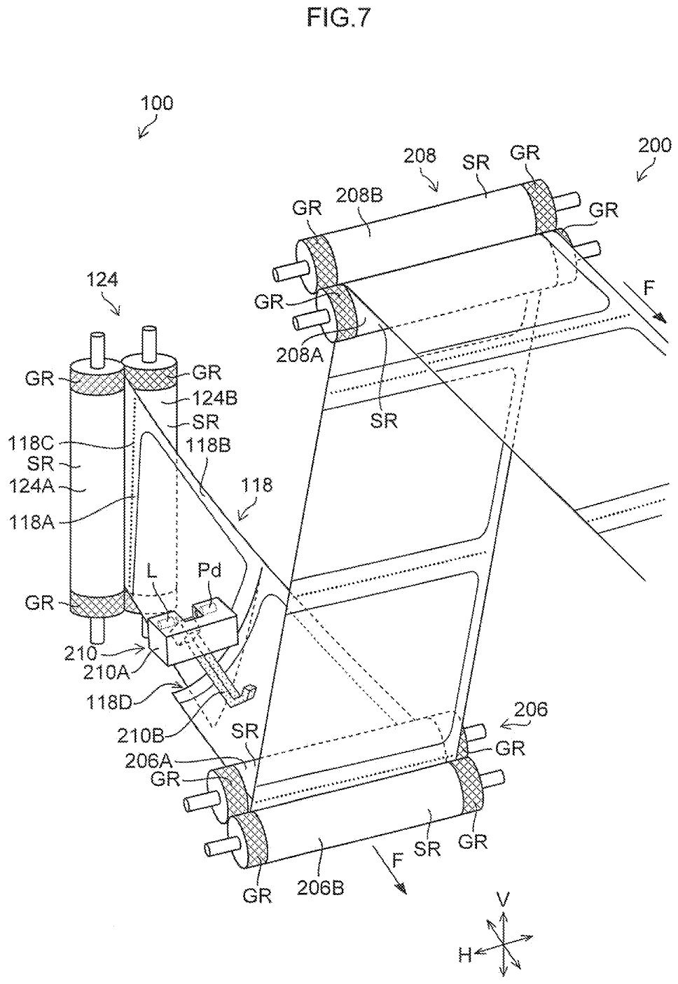

Description is now given of the operation of the conveyor 200 based on FIGS. 4 to 7. FIGS. 4 and 5 are drawings for describing the operation with the cut line not generated in the portion packaging bags 118. FIGS. 6 and 7 are drawings for describing the operation with the cut line generated on the portion packaging bags 118.

As shown in FIGS. 4 and 5, a pair of roller parts 124 is arranged along a vertical direction on the upstream side of the discharge port 120 of the portion packaging machine 100. The pair of roller parts 124 is arranged so as to face each other across the portion packaging bags 118 to press the portion packaging bags 118. The pair of roller parts 124 adjusts the posture of the portion packaging bags 118 to the longitudinal direction. The pair of roller parts 124 is constituted of two rollers 124A and 124B. For example, one of the rollers 124A and 124B is constituted as a drive roller and the other is constituted as a driven roller. The drive roller is coupled to the drive source and rotates by itself. The driven roller is not coupled to the drive source and is rotatably pivoted. When in contact with the drive roller, the driven roller rotates with the rotation of the drive roller.

The rollers 124A and 124B each include a sponge roller SR and rubber rollers GR at both ends of the sponge roller SR. Because there is no medicine in the lateral seal portion 118B, the two rubber rollers GR arranged on the side of the lateral seal portion 118B can strongly press the lateral seal portion 118B. The portion packaging bags 118 can be fed in the conveying direction.

The two rubber rollers GR at positions opposite to the rubber rollers GR that press the lateral seal portion 118B come into contact with each other outside the portion packaging bag 118 without pressing the portion packaging bag 118. Since the rollers 124A and 124B have the rubber rollers GR at each end, drive force can be transferred from the drive roller to the driven roller.

The sponge rollers SR are softer than rubber rollers GR. When the portion packaging bag 118 is pressed by the rollers 124A and 124B, the sponge rollers SR can prevent the portion-packaged medicine from being damaged.

The embodiment shows a configuration in which both the rollers 124A and 124B include the rubber rollers GR and the sponge roller SR. Without being limited to the configuration, the rollers 124A and 124B may be configured such that one roller includes the rubber rollers GR and the sponge roller SR, and the other includes only the rubber roller GR without the sponge roller SR.

The portion packaging bags 118 discharged from the discharge port 120 pass through the introduction port 202 of the conveyor 200 and are conveyed toward the pair of roller parts 206. The pair of roller parts 206 is constituted of a first roller 206A and a second roller 206B. The first roller 206A is perpendicular to a conveying direction F and arranged in a horizontal direction. The second roller 206B is arranged facing the first roller 206A to press the portion packaging bags 118 with the first roller 206A.

The portion packaging bags 118, which have passed through the pair of roller parts 206, are conveyed toward the pair of roller parts 208. The pair of roller parts 208 includes a third roller 208A and a fourth roller 208B. The third roller 208A is arranged vertically above the first roller 206A and in the horizontal direction, and is in a positional relation parallel to the first roller 206A. The fourth roller 208B is arranged facing the third roller 208A. The third roller 208A and the fourth roller 208B press the portion packaging bags 118.

Similar to the pair of roller parts 124, the first roller 206A and the second roller 206B, which constitute the pair of roller parts 206, can each include a sponge roller SR and rubber rollers GR at both ends of the sponge roller SR. The third roller 208A and the fourth roller 208B, which constitute the pair of roller parts 208, can each include a sponge roller SR and rubber rollers GR at both ends of the sponge roller SR. The pair of roller parts 206 and the pair of roller parts 208 can each be configured such that one roller part includes the rubber rollers GR and the sponge roller SR, and the other roller part includes only the rubber roller GR without the sponge roller SR.

The conveyor 200 can arrange a pair of rollers (not shown), similar to the pair of the roller parts 124, arranged between the introduction port 202 and the pair of roller parts 206 along the vertical direction.

In the embodiment, the first roller 206A functions as a posture changing device that changes the longitudinal posture of the portion packaging bags 118 to a lateral posture. The portion packaging bags 118 are wound around the first roller 206A and are given tension from the first roller 206A. The portion packaging bags 118 are twisted about 90°, so that the longitudinal posture is changed to the lateral posture. The lateral posture is such that the short direction of the continuous portion packaging bags 118 is along the lateral direction. As shown in FIG. 5, the lower side of the double-folded portion of each of the portion packaging bags 118 is twisted clockwise as viewed from the direction opposite to the conveying direction F. The portion packaging bags 118 can also be twisted counter-clockwise.

In the embodiment, the third roller 208A guides the conveyed portion packaging bags 118 in a vertically upward direction and the horizontal direction. The third roller 208A maintains the portion packaging bags 118 in a lateral posture. The portion packaging bags 118 are fed from the discharge port 204 to the inspecting machine 300 in the lateral posture.

The conveyor 200 includes a detector 210. As shown in FIG. 5, the detector 210 is arranged on the side where the lower side of the double-folded portion of the portion packaging bags 118 moves. The detector 210 includes a photosensor 210A and an actuator 210B. The photosensor 210A has a light-emitting element L and a light-receiving element Pd arranged so as to face each other with a distance. An optical path is formed between the light-emitting element L and the light-receiving element Pd. The detector 210 is arranged in the state of forming a positional relation in which the optical path is perpendicular to the conveying direction F and in the horizontal direction. Output of the photosensor 210A varies depending on an optical path blocking state and an optical path opening state. The configuration of the light-emitting element L is not particularly limited, and a light emitting diode, etc. can be applied. The configuration of the light-receiving element Pd is not particularly limited, and a photodiode, a photo integrated circuit (IC), etc. can be applied. Note that the detector 210 may be arranged in consideration of the characteristics of the perforations of the portion packaging bags 118, and the arrangement position of the detector 210 is not limited to the position of the lower side of the double-folded portion. It is also possible to arrange two or more detectors 210.

The actuator 210B is provided on the photosensor 210A rotatably around a rotation shaft (not shown) along the optical path. The actuator 210B rotationally moves around the rotation shaft in response to contact with the portion packaging bags 118. The actuator 210B determines one state out of the optical path blocking state and the optical path opening state of the photosensor 210A as the actuator 210B rotationally moves. The photosensor 210A outputs signals corresponding to the optical path blocking and the optical path opening. For example, the photosensor 210A can take a mode of outputting Low in the optical path blocking state and High in the optical path opening state or a mode of outputting High in the optical path blocking state and Low in the optical path opening state.

As shown in FIG. 5, the portion packaging bags 118 are in the state where no cut line is generated. When the portion packaging bags 118 are in the state where no cut line is generated, the actuator 210B of the detector 210 is in non-contact with the portion packaging bags 118. In the embodiment, the actuator 210B is at the position of an initial state corresponding to the non-contact with the portion packaging bags 118. The actuator 210B in the initial state blocks the optical path. The photosensor 210A outputs Low in response to the optical path blocking. The output signal from the detector 210 is input into the controller 500.

As shown in FIGS. 6 and 7, one portion packaging bag 118 has an unintentional cut line 118D along the perforations 118C. When the portion packaging bags 118 are changed from the longitudinal posture to the lateral posture, tension is applied to the portion packaging bags 118, which makes it more likely to generate the cut line 118D particularly along the perforations 118C of the portion packaging bags 118. The cut line 118D is a partial cut of the portion packaging bag 118, which is not large enough to separate the portion packaging bag 118.

At the time of conveying operation, a moving track of a double-folded lower end when the cut line 118D is generated is different from a moving track of the double-folded lower end before generation of the cut line 118D (referred to as normal position). When the cut line 118D is generated, the moving track of the double-folded lower end is located on the upper side in the vertical direction as compared with the normal position.

As a result, in the embodiment, the portion packaging bag 118 comes into contact with the actuator 210B, and the actuator 210B rotates around the rotation shaft from the initial state. When the actuator 210B rotates at angles larger than an angle specified based on the initial condition, the actuator 210B opens the optical path of the photosensor 210A. In the embodiment, the photosensor 210A outputs High in response to the optical path opening. The output signal from the detector 210 is input into the controller 500.

The controller 500 determines the presence or absence of the cut line 118D in the portion packaging bag 118 based on output difference between the portion packaging bag 118 without the cut line 118D and the portion packaging bag 118 with the cut line 118D. When the controller 500 determines the presence of the cut line 118D, then the controller 500 can stop the operation of the medicine inspection support system 10 and/or issue an alarm by activating a buzzer, a lamps, etc. to inform the operator, for example. The controller 500 can stop operation of the medicine inspection support system 10 and/or issue an alarm in accordance with the detection result of the detector 210 (with the generation of the cut line 118D). This makes it possible to promptly cope with the generation of the cut line in any of the portion packaging bags 118.

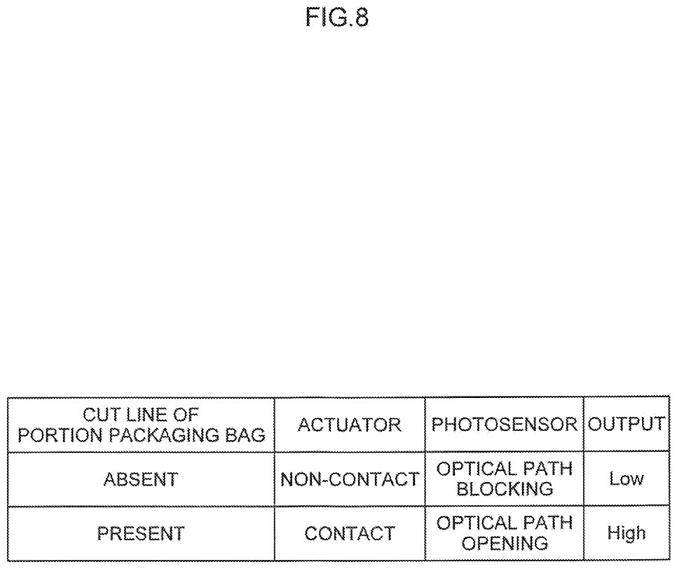

FIG. 8 is a table showing the outlined operation in the embodiment. When no cut line is generated in the portion packaging bags 118, the portion packaging bags 118 and the actuator 210B of the detector 210 are not in contact. The actuator 210B blocks the optical path of the photosensor 210A, and the photosensor 210A outputs a Low signal. On the other hand, when the cut line 118D is generated in any of the portion packaging bags 118, the portion packaging bag 118 and the actuator 210B of the detector 210 are in contact. The actuator 210B opens the optical path of the photosensor 210A, and the photosensor 210A outputs a High signal. As long as different signals are output from the detector 210 in response to the presence or absence of the cut line 118D in the portion packaging bags 118, no restriction is imposed on the operation of the actuator and the photosensor is not limited.

In the embodiment, while the first roller 206A has been illustrated as the posture changing device, the guide can change the longitudinal posture to the lateral posture. The portion packaging bags 118 are conveyed along the guide, and the longitudinal posture is changed to the lateral posture. For example, the guide supports the lateral seal portion 118B of the portion packaging bags 118. The guide has a predetermined length and extends downward along the conveying direction F and diagonally across the conveying direction F. The configuration of the posture changing device is not particularly limited.

Although the detector 210 configured to include the photosensor 210A and the actuator 210B has been illustrated, a transmission photosensor, a reflection photosensor, etc. can be applied.

The transmission photosensor has a light-emitting element and a light-receiving element arranged so as to face each other, and an optical path is formed between the light-emitting element and the light-receiving element. The transmission photosensor is arranged at the position where the portion packaging bags cross the optical path in the state where no cut line is generated and where the portion packaging bags do not cross the optical path in the state where the cut line is generated. When the portion packaging bags are transparent, the transmission photosensor outputs some signal, regardless of the state where no cut line is generated and the state where the cut line is generated. On the other hand, the output from the transmission photosensor is different in magnitude between in the state where no cut line is generated and in the state where no cut line is generated. By determining the magnitude of the output, the presence or absence of the cut line can be detected.

The reflection photosensor has a light-emitting element and a light-receiving element juxtaposed to face the same direction. The reflection photosensor is arranged at the position where the light-receiving element receives the light of the light-emitting element reflected by the portion packaging bags in the state where no cut line is generated and where the light-receiving element does not receive the light of the light-emitting element in the state where the cut line is generated. The output from the reflection photosensor is different in magnitude between in the state where no cut line is generated and in the state where no cut line is generated. By determining the magnitude of the output, it is possible to detect the presence or absence of the cut line.

Hardware that implements the controller 500 according to the embodiment can be constituted of various processors. The various processors include a central processing unit (CPU) that is a general-purpose processor that executes programs and functions as various processing parts, a programmable logic device (PLD) that is a processor capable of changing circuit configuration after manufacturing, such as a field programmable gate array (FPGA), and an exclusive electrical circuit that is a processor having a circuit configuration exclusively designed for execution of specific processes, such as application specific integrated circuit (ASIC). One processing part constituting an image display device may be constituted of one of the various processors, or may be constituted of two or more processors of the same kind or different kinds. For example, one processing part may be constituted of a plurality of FPGAs or a combination of a CPU and an FPGA. One processor may constitute a plurality of processing parts. As an example of one processor constituting a plurality of processing parts, firstly, there is a configuration, as represented by a computer such as a client or a serve, where a combination of one or more CPUs and software constitutes one processor, and the one processor functions as a plurality of processing parts. Secondary, there is a configuration of using a processor which implements the function of the entire system including a plurality of processing parts with a single integrated circuit (IC) chip, as represented by a system on chip (SoC) or the like. In this way, the various processing parts are configured with one or more of the various processors in terms of the hardware structure. Furthermore, the hardware structures of the various kinds of processors correspond to electrical circuits (circuitries) formed by combining circuit elements such as semiconductor elements to be more specific.

The operation of the medicine inspection support system 10 according to the embodiment is described (with reference to FIGS. 1 to 7). Medicine is prepared for a plurality of feeders 104, and the portion packaging paper 112 is prepared for the supply mechanism 114. The controller 500 controls the feeders 104 based on prescription data, and the feeders 104 supply medicine of one dose to the packaging mechanism 110. The controller 500 controls the packaging mechanism 110. The portion packaging paper 112 is intermittently conveyed from the supply mechanism 114, and the heat seal mechanism 116 forms longitudinal seal portions 118A on the portion packaging paper 112 and forms perforations 118C. Medicine is supplied from the input pipe 108 to the portion packaging paper 112. The portion packaging paper 112 is intermittently conveyed, and the heat seal mechanism 116 forms lateral seal portions 118B on the portion packaging paper 112. The portion packaging machine 100 discharges the portion packaging bags 118 in a longitudinal posture.

The conveyor 200 receives the portion packaging bags 118 in the longitudinal posture from the introduction port 202. The posture of the portion packaging bags 118 is changed to a lateral posture by passing through the pair of roller parts 206 including the first roller 206A serving as the posture changing device. The portion packaging bags 118 are fed to the inspecting machine 300 in the lateral posture by passing through the pair of roller parts 208 including the third roller 208A. When the detector 210 detects the cut line 118D in any of the portion packaging bags 118, the controller 500 stops operation of the medicine inspection support system 10.

The inspecting machine 300 receives the portion packaging bags 118 in the lateral posture from the introduction port 302. The controller 500 controls the first conveying rollers 304 and the second conveying rollers 306 to convey the portion packaging bags 118 to the imaging area. The controller 500 controls the light sources 312, the first camera 308 and the second camera 310 to image the portion packaging bags 118 in the lateral posture from the upper and lower directions and thereby acquire medicine images.

The controller 500 retrieves medicine data including images from the prescription data. The controller 500 uses the medicine data and medicine images to determine whether inspection target medicines are identical to the medicines indicated by the prescription data, and then outputs inspection result information. The controller 500 controls the label printer mechanism 316 to attach labels having the prescription data and the inspection result information printed thereon to the portion packaging bags 118. The controller 500 controls the third conveying rollers 332. The third conveying rollers 332 discharge the portion packaging bags 118 attached with the labels to the housing box 400 through the discharge port 334.

As described in the foregoing, the conveyor 200 changes the portion packaging bags 118 from the longitudinal posture to the lateral posture, and detects the cut line 118D of the portion packaging bags 118.

In the embodiment, the case where the portion packaging machine 100, the conveyor 200, and the inspecting machine 300 each have a separate casing has been described. However, without being limited to the configuration, the portion packaging machine 100, the conveyor 200 and the inspecting machine 300 may be housed in a single casing.

### EXPLANATION OF REFERENCES

10 Medicine inspection support system
100 portion packaging machine
102 Casing
104 Feeder
106 Hopper
108 Input pipe
110 Packaging Mechanism
112 Portion packaging paper
114 Supply mechanism
116 Heat seal mechanism
116A Longitudinal heat head
116B Lateral heat head
118 Portion packaging bag
118A Longitudinal seal portion
118B Lateral seal portion
118C Perforations
118D Cut line
120 Discharge port
122 Printhead
124A pair of roller parts
124A Roller
124B Roller
200 Conveyor
201 Casing
202 Introduction port
204 Discharge port
206A pair of roller parts
206A First roller
206B Second roller
208A pair of roller parts
208A Third roller
208B Fourth roller
210 Detector
210A Photosensor
210B Actuator
300 Inspecting machine
301 Casing
302 Introduction port
304 First conveying rollers
306 Second conveying rollers
308 First camera
310 Second camera
312 Light source
314 Guide
316 Label printer mechanism
318 Backing paper
320 Supply mechanism
322 Label printer
324 Label release mechanism
326 Winding mechanism
330 Third camera
332 Third conveying roller
334 Discharge port
400 Housing box
500 Controller
502 Display part
504 Operating part
506 Processing part
508 Storage part
510 Communication interface
F Conveying direction
L Light-emitting element
Pd Light-receiving element

What is claimed is:

1. A conveyor that conveys portion packaging bags to an inspecting machine, the portion packaging bags being divided one by one with use of a heat seal portion and perforations by a portion packaging machine and being continuously discharged in a longitudinal posture from the portion packaging machine, the conveyor comprising:
a posture changing device configured to change the longitudinal posture of the portion packaging bags to a lateral posture; and
a detector configured to detect a cut line in each of the portion packaging bags.

2. The conveyor according to claim 1, wherein
the detector is arranged on an upstream side of the posture changing device.

3. The conveyor according to claim 1, wherein
the detector includes a photosensor having a light-emitting element and a light-receiving element arranged so as to face each other with a distance; and
an actuator configured to determine one state out of an optical path blocking state and an optical path opening state of the photosensor in response to contact with the portion packaging bag.

4. The conveyor according to claim 3, wherein the actuator determines optical path opening of the photosensor in response to contact with the portion packaging bags.

5. The conveyor according to claim 1, wherein the posture changing device is a first roller arranged in a direction perpendicular to a conveying direction of the portion packaging bags and in a horizontal direction.

6. The conveyor according to claim 5, comprising a second roller configured to press the portion packaging bags together with the first roller, the second roller being arranged so as to face the first roller.

7. The conveyor according to claim 1, wherein the posture changing device is a guide.

8. The conveyor according to claim 5, comprising a third roller configured to guide the portion packaging bags that have passed the posture changing device in a vertically upward direction and a horizontal direction.

9. A medicine inspection support system, comprising:
a portion packaging machine configured to portion-package medicine based on prescription data, and continuously discharge portion packaging bags in a longitudinal posture, the portion packaging bags being divided one by one with use of a heat seal portion and perforations;
the conveyor configured to convey the portion packaging bags discharged from the portion packaging machine according to claim 1; and
an inspecting machine configured to receive the portion packaging bags continuously fed from the conveyor and inspect the medicine portion-packaged into the portion packaging bags based on the prescription data.

10. The medicine inspection support system according to claim 9, comprising a controller configured to control the portion packaging machine, the conveyor, and the inspecting machine, wherein
the controller stops operation of the medicine inspection support system and/or issues an alarm in accordance with a result of the detector of the conveyor.
